(19) United States
(12) Patent Application Publication
(10) Pub. No.: US 2015/0024272 A1
(43) Pub. Date: Jan. 22, 2015

(54) CATHODE ACTIVE MATERIAL FOR LITHIUM ION SECONDARY BATTERY

(71) Applicant: ASAHI GLASS COMPANY, LIMITED, Chiyoda-ku (JP)

(72) Inventor: Kentaro TSUNOZAKI, Chiyoda-ku (JP)

(73) Assignee: ASAHI GLASS COMPANY, LIMITED, Chiyoda-ku (JP)

(21) Appl. No.: 14/510,625

(22) Filed: Oct. 9, 2014

Related U.S. Application Data
(63) Continuation of application No. PCT/JP2013/060873, filed on Apr. 10, 2013.

(30) Foreign Application Priority Data
Apr. 11, 2012 (JP) 2012-090395

(51) Int. Cl. H01M 4/36; H01M 4/525; C01G 53/00; H01M 4/131; H01M 4/1391; H01M 4/04; H01M 4/505; H01M 4/62

(52) U.S. Cl. CPC H01M 4/366; H01M 4/505; H01M 4/525; H01M 4/62; H01M 4/131; H01M 4/1391; H01M 4/0419; C01G 53/50; H01M 2004/028
USPC 429/223; 427/126.1

(57) ABSTRACT

To provide a cathode active material for a lithium ion secondary battery excellent in the cycle characteristics, even when charging is carried out under a high voltage.

A cathode active material for a lithium ion secondary battery, characterized in that Al and at least one member selected from the group consisting of Y, Gd and Er are present on the surface of particles (1) made of a lithium-containing composite oxide containing Li and at least one transition metal element selected from the group consisting of Ni, Co and Mn.

### TECHNICAL FIELD

The present invention relates to a cathode active material for a lithium ion secondary battery and a process for its production. Further, the present invention relates to a cathode for a lithium ion secondary battery, and a lithium ion secondary battery, employing the cathode active material for a lithium ion secondary battery.

### BACKGROUND ART

In recent years, lithium ion secondary batteries are widely used for portable electronic instruments such as cell phones or notebook-size personal computers. As a cathode active material for a lithium ion secondary battery, a composite oxide of lithium with a transition metal element, etc. (hereinafter referred to also as a lithium-containing composite oxide), such as LiCoO₂, LiNiO₂, LiNi_{0.8}Co_{0.2}O₂ or LiMn₂O₄, is employed.

Particularly, a lithium ion secondary battery using LiCoO₂ as a cathode active material and using a lithium alloy, graphite or carbon fiber as an anode, is widely used as a battery having a high energy density, since a high voltage at a level of 4 V can thereby be obtainable.

Further, in recent years, for a lithium ion secondary battery for portable electronic instruments or vehicles, it is desired to reduce the size and weight, and it is desired to further improve the discharge capacity per unit mass (hereinafter simply referred to as discharge capacity) or it is desired to further improve such characteristics that the discharge capacity or the average discharge voltage will not substantially decrease after repeating the charge and discharge cycle (hereinafter referred to also as cycle characteristics).

For example, in order to improve the discharge capacity, Patent Document 1 discloses an active material for a lithium secondary battery containing a solid solution of a lithium transition metal composite oxide having an α-NaFeO₂ type crystal structure, wherein the compositional ratio of a lithium element and transition metal elements contained in the solid solution satisfies the compositional formula Li_{1+1/3x}Co_{1-x-y}Ni_{y/2}Mn_{2x/3+y/2} (x+y≦1, 0≦y, and ⅓<x≦⅔).

However, in a cathode active material wherein the compositional ratio (molar ratio) of Li to the transition metal elements is at least 1, manganese element is contained in a large amount in the transition metals. Such manganese element is likely to elute in an electrolyte when it is in contact with a decomposition product produced from the electrolyte by charging under a high voltage, and therefore, the crystal structure of the cathode active material becomes unstable.

Accordingly, particularly by repetition of charging and discharging, the cycle characteristics tend to decrease, and therefore it has been required to improve the cycle characteristics.

For the purpose of improving such cycle characteristics, Patent Document 2 discloses that the surface of a lithium-containing composite oxide is covered with an oxide such as Al₂O₃, ZrO₂ or MgO. However, even when such covering treatment is carried out, it has been difficult to suppress decrease of the average discharge voltage at the time of repetition of charging and discharging, and therefore it has been difficult to obtain sufficient cycle characteristics.

### PRIOR ART DOCUMENT

### Patent Document

Patent Document 1: JP-A-2009-152114

Patent Document 2: WO_{2011/031544}

### DISCLOSURE OF INVENTION

### Technical Problem

Under these circumstances, the object of the present invention is to provide a cathode active material for a lithium ion secondary battery excellent in the cycle characteristics even when charged under a high voltage, a process for producing a cathode active material for a lithium ion secondary battery for obtaining such a cathode active material, and a cathode for a lithium ion secondary battery and a lithium ion secondary battery, employing the cathode active material for a lithium ion secondary battery.

### Solution to Problem

The present invention provides a cathode active material for a lithium ion secondary battery, a cathode for a lithium ion secondary battery, a lithium ion secondary battery, and a process for producing a cathode active material for a lithium ion secondary battery, having the following [1] to [13].

[1] A cathode active material for a lithium ion secondary battery, characterized in that Al and at least one member selected from the group consisting of Y, Gd and Er are present on the surface of particles (1) made of a lithium-containing composite oxide containing Li and at least one transition metal element selected from the group consisting of Ni, Co and Mn.
[2] The cathode active material for a lithium ion secondary battery according to [1], wherein the lithium-containing composite oxide is represented by the following formula (2-1):

Li(LiₓMn_{y}Me_{z})OₚF_{q} (2-1)

wherein Me is at least one element selected from the group consisting of Co and Ni, 0.11≦x≦_{0.22, 0.55≦}y/(y+z)<0.75, x+y+z=1, 1.9<p<2.1, and 0≦q≦0.1.
[3] The cathode active material for a lithium ion secondary battery according to [1] or [2], wherein the molar amount of the above Al is from 0.001 to 0.05 time the total molar amount of the transition metal element.
[4] The cathode active material for a lithium ion secondary battery according to any one of [1] to [3], wherein the total molar amount of at least one member selected from the group consisting of Y, Gd and Er is from 0.0005 to 0.015 time the total molar amount of the transition metal element.
[5] The cathode active material for a lithium ion secondary battery according to any one of [1] to [4], wherein the total molar amount of at least one member selected from the group consisting of the above Y, Gd and Er is from 0.01 to 1.0 time the molar amount of the above Al.
[6] The cathode active material for a lithium ion secondary battery according to any one of [1] to [5], which is composed of particles (2) wherein Al₂O₃ and at least one member selected from the group consisting of Y₂O₃, Gd₂O₃ and Er₂O₃ are present on the surface of the particles (1) made of the lithium-containing composite oxide.
[7] A process for producing a cathode active material for a lithium ion secondary battery, which comprises:

a first contact step of contacting particles (1) made of a lithium-containing composite oxide containing Li and at least one transition metal element selected from the group consisting of Ni, Co and Mn, with the following composition (1), a second contact step of contacting the above particles (1) with the following composition (2), and

a heating step of heating particles obtained by the above first contact step and the above second contact step:

composition (1): a solution or dispersion containing a compound (α) containing Al and a medium;

composition (2): a solution or dispersion containing a compound (13) containing at least one member selected from the group consisting of Y, Gd and Er, and a medium.

[8] The process for producing a cathode active material for a lithium ion secondary battery according to [7], wherein the above compound (α) is at least one member selected from the group consisting of aluminum lactate, aluminum acetate, basic aluminum lactate and aluminum nitrate.
[9] The process for producing a cathode active material for a lithium ion secondary battery according to [7] or [8], wherein the above compound (13) is at least one member selected from the group consisting of a lactate, acetate, citrate, formate and nitrate of Y, Gd or Er.
[10] The process for producing a cathode active material for a lithium ion secondary battery according to any one of [7] to [9], wherein the lithium-containing composite oxide is represented by the following formula (2-1):

Li(LiₓMn_{y}Me_{z})OₚF_{q} (2-1)

wherein Me is at least one element selected from the group consisting of Co and Ni, 0.11≦x≦_{0.22, 0.55≦}y/(y+z)≦0.75, x+y+z=1, 1.9<p<2.1, and 0≦q≦0.1.
[11] The process for producing a cathode active material for a lithium ion secondary battery according to any one of [7] to [10], wherein the above first contact step and the above second contact step are carried out by a spray coating method.
[12] A cathode for a lithium ion secondary battery, comprising the cathode active material for a lithium ion secondary battery as defined in any one of [1] to [6], an electrically conductive material and a binder.
[13] A lithium ion secondary battery comprising the cathode as defined in [12], an anode and a non-aqueous electrolyte.

### Advantageous Effect of Invention

According to the cathode active material for a lithium ion secondary battery of the present invention, the cycle characteristics are excellent even when charging is carried out under a high voltage.

Further, according to the production process of the present invention, a cathode active material for a lithium ion secondary battery excellent in the cycle characteristics even when charging is carried out under a high voltage can be produced with a good productivity.

Moreover, according to the cathode for a lithium ion secondary battery, and the lithium ion secondary battery using the cathode active material, of the present invention, excellent cycle characteristics can be achieved even when charging is carried out under a high voltage.

### DESCRIPTION OF EMBODIMENTS

In this specification, the representation of “Li” represents Li element. The same applies to other representations such as Al, Y, Gd and Er. Further, in the present invention, the phrase “Al and at least one member selected from the group consisting of Y, Gd and Er are present on the surface of particles (1)” means that a compound containing Al and a compound containing at least one element selected from the group consisting of Y, Gd and Er are present on the surface of the particles (1) or that a composite compound containing Al and at least one member selected from the group consisting of Y, Gd and Er is present on the surface of the particles (1).

### <Lithium-Containing Composite Oxide>

The lithium-containing composite oxide in the present invention contains Li and at least one transition metal element selected from the group consisting of Ni, Co and Mn.

As the transition metal element in the lithium-containing composite oxide, it preferably contains at least Mn, more preferably contains all the elements of Ni, Co and Mn.

The lithium-containing composite oxide may contain elements other than Ni, Co, Mn and Li. Such other elements may, for example, be Ca, Sr, Ba, Nb, Ag, Cr, Fe, Al, Ti, Zr, Mg and Mo.

The lithium-containing composite oxide is preferably a compound (i) represented by the following formula (1), a compound (ii) represented by the following formula (2-1) or a compound (iii) represented by the following formula (3). These compounds may be used alone or in combination of two or more of them. The lithium-containing composite oxide is more preferably the compound (ii), particularly preferably a compound represented by the following formula (2-2) in view of a high discharge capacity.

### (Compound (i))

The compound (i) is a compound represented by the following formula (1):

Liₐ(NiₓMn_{y}CO_{z})Me_{b}O₂ (1)

wherein Me is at least one member selected from the group consisting of Mg, Ca, Sr, Ba, Zr and Al, and 0.95≦a≦1.1, 0≦x, y, z≦1, 0≦b≦0.3, 0.90≦x+y+z+b≦1.05.

In the formula (1), it is more preferred that 0.97≦a≦1.05, 0≦x, y, z≦1, 0≦b≦0.1, 0.95≦x+y+z+b≦1.03.

The compound (i) may be LiCoO₂, LiNiO₂, LiMnO₂, LiMn_{0.5}Ni_{0.5}O₂, LiNi_{0.5}Co_{0.2}Mn_{0.3}O₂, LiNi_{0.85}Co_{0.10}Al_{0.05}O₂ or LiNi_{1/3}Co_{1/3}Mn_{1/3}O₂.

(Compound (ii))

The compound (ii) is a compound represented by the following formula (2-1). The representation of the compound represented by the formula (2-1) is for the compositional formula before charge and discharge or a treatment such as activation. Here, activation means to remove lithium oxide (Li₂O) or lithium and lithium oxide from the lithium-containing composite oxide. As a usual activation method, an electrochemical activation method of charging at a voltage higher than 4.4 V or 4.6 V (a value represented by a potential difference with Li⁺/Li oxidation-reduction potential) may be mentioned. Further, a chemical activation method of carrying out a chemical reaction using an acid such as sulfuric acid, hydrochloric acid or nitric acid may be mentioned.

Li(LiₓMn_{y}Me_{z})OₚF_{q} (2-1)

In the formula (2-1), Me is at least one member selected from the group consisting of Co, Ni, Cr, Fe, Al, Ti, Zr and Mg. Further, in the formula (2-1), 0.09<x<0.25, y>0, z>0, 1.9<p<2.1 and 0≦q≦0.1, and 0.55≦y/(y+z)≦0.8, x+y+z=1 and 1.2<(1+x)/(y+z).

In the compound (ii), the molar amount of Li exceeds 1.2 molar times the total amount of Mn and Me′. Further, the compound (ii) is also characterized by containing Mn in a specific amount, and the proportion of Mn to the total amount of Mn and Me′ is preferably from 0.55 to 0.8, more preferably from 0.6 to 0.75. When Mn is within the above range, higher discharge capacity is obtained. Here, q represents the proportion of F, and is 0 when F is not present. Further, p is a value determined by x, y, z and q, and is from 1.9 to 2.1.

Me′ is preferably at least one element selected from the group consisting of Co and Ni. In such a case, it is particularly preferred that 0.11≦x≦_{0.22}, y>0, z>0, 1.9<p<2.1, 0≦q≦0.1 and further 0.55≦y/(y+z)≦0.75, x+y+z=1, 1.2<(1+x)/(y+z) in view of excellent battery characteristics.

In the compound (ii), the compositional ratio of Li to the total molar amount of the transitional metal element is preferably 1.2<(1+x)/(y+z)<1.6, more preferably 1.25≦(1+x)/(y+z)≦1.55, particularly preferably 1.3≦(1+x)/(y+z)≦1.5. When this compositional ratio is within the above range, a cathode active material having a high discharge capacity is obtained when a high charge voltage of at least 4.6 V is applied.

The compound (ii) is more preferably a compound represented by the following formula (2-2).

Li(LiₓMn_{y}NiᵥCo_{w})Oₚ (2-2)

wherein 0.09<x<0.25, 0.5<y<0.73, 0<v<0.41, 0<w<0.2, 1.9<p<2.1, x+y+v+w=1.

In the formula (2-2), the compositional ratio of the Li element to the total of elements of Mn, Li and Co is 1.2<(1+x)/(y+v+w)<1.67, preferably 1.2<(1+x)/(y+v+w)≦1.6, more preferably 1.25≦(1+x)/(y+v+w)≦1.55, particularly preferably 1.3≦(1+x)/(y+v+w)≦1.5.

The compound (ii) is particularly preferably Li(Li_{0.13}Ni_{0.26}Co_{0.09}Mn_{0.52})O₂, Li(Li_{0.13}Ni_{0.22}Co_{0.09}Mn_{0.56})O₂, Li(Li_{0.13}Ni_{0.17}Co_{0.17}Mn_{0.53})O₂, Li(Li_{0.15}Ni_{0.17}Co_{0.13}Mn_{0.55})O₂, Li(Li_{0.16}Ni_{0.17}Co_{0.08}Mn_{0.59})O₂, Li(Li_{0.17}Ni_{0.17}Co_{0.17}Mn_{0.49})O₂, Li(Li_{0.17}Ni_{0.21}Co_{0.08}Mn_{0.54})O₂, Li(Li_{0.17}Ni_{0.14}Co_{0.14}Mn_{0.55})O₂, Li(Li_{0.18}Ni_{0.12}Co_{0.12}Mn_{0.58})O₂, Li(Li_{0.18}Ni_{0.16}Co_{0.12}Mn_{0.54})O₂, Li(Li_{0.20}Ni_{0.12}Co_{0.08}Mn_{0.06})O₂, Li(Li_{0.20}Ni_{0.16}Co_{0.08}Mn_{0.56})O₂ or Li(Li_{0.20}Ni_{0.13}Co_{0.13}Mn_{0.54})O₂.

The compound (ii) is preferably one having a layered rock salt type crystal structure (space group R-3m). Further, as the proportion of the Li to the transition metal element is high in the compound (ii), in the XRD (X-ray diffraction) measurement using CuKα ray as the X-ray source, a peak is observed within a range of 2θ=20 to 25° like layered Li₂MnO₃.

(Compound (iii))

The compound (iii) is a compound represented by the following formula (3):

Li(Mn₂₋ₓMe″ₓ)O₄ (3)

In the formula (3), Me″ is at least one member selected from the group consisting of Co, Ni, Fe, Ti, Cr, Mg, Ba, Nb, Ag and Al, and 0≦x<2. The compound (iii) may be LiMn₂O₄, LiMn_{1.5}Ni_{0.5}O₄, LiMn_{1.85}Al_{0.15}O₄ or LiMn_{1.9}Mg_{0.1}O₄.

The lithium-containing composite oxide in the present invention is in the form of particles. The shape of the particles is not particularly limited and may be spherical, needle-form, plate-form or the like. However, it is preferably spherical since it is thereby possible to increase a filling ability. Further, a plurality of such particles may be agglomerated to form secondary particles, and also in such a case, spherical secondary particles are preferred, which are capable of increasing the filling ability.

In the present invention, the average particle size (D50) of the lithium-containing composite oxide is preferably from 3 to 30 μm, more preferably from 4 to 25 μm, particularly preferably from 5 to 20 μm.

In the present invention, the average particle size (D50) means a volume-based accumulative 50% size which is a particle size at a point of 50% on an accumulative curve when the accumulative curve is drawn by obtaining the particle size distribution on the volume basis and taking the whole to be 100%.

The particle size distribution is obtained from the frequency distribution and accumulative volume distribution curve measured by means of a laser scattering particle size distribution measuring apparatus. The measurement of particle sizes is carried out by sufficiently dispersing the powder in an aqueous medium by e.g. ultrasonic treatment and measuring the particle size distribution, for example, by means of a laser diffraction/scattering type particle size distribution measuring apparatus (trade name: Partica LA-950VII), manufactured by HORIBA, Ltd.

The specific surface area of the lithium-containing composite oxide in the present invention is preferably from 0.1 to 15 m²/g, particularly preferably from 0.15 to 10 m2/g.

In a case where the lithium-containing composite oxide is a compound selected from the compound (i) and the compound (iii), the specific surface area is preferably from 0.1 to 1 m²/g, more preferably from 0.15 to 0.6 m²/g.

In a case where the lithium-containing composite oxide is a compound selected from the compound (ii), the specific surface area is preferably from 1 to 15 m²/g, more preferably from 2 to 10 m²/g, particularly preferably from 3 to 8 m²/g. When the specific surface area of the lithium-containing composite oxide is from 0.1 to 15 m²/g, it is possible to form a dense cathode layer having a high discharge capacity. Here, the specific surface area is a value measured by means of a BET (Brunauer, Emmett, Teller) method.

A method for producing the lithium-containing composite oxide may, for example, be a method wherein a precursor (coprecipitated composition) for a lithium-containing composite oxide obtained by a coprecipitation method and a lithium compound (such as lithium carbonate or lithium hydroxide) are mixed and fired, a hydrothermal synthesis method, a sol-gel method, a dry blending method (solid phase method), an ion exchange method or a glass crystallization method.

Further, preferred is a method wherein a precursor for a lithium-containing composite oxide obtained by a coprecipitation method and a lithium compound are mixed and fired, whereby transition metal elements will be uniformly contained in a lithium-containing composite oxide, so that higher discharge capacity is obtained.

The cathode active material for a lithium ion secondary battery of the present invention is one composed of particles (hereinafter referred to as particles (2)) wherein Al and at least one member (hereinafter also referred to as element (X)) selected from the group consisting of Y, Gd and Er are present on the surface of the particles (1) made of a lithium-containing composite oxide.

Al and element (X) may be present at least at a part of the surface of the particles (1), and are preferably present on the entire surface of the particles (1) from the viewpoint of obtaining more excellent cycle characteristics.

In the particles (2), Al and element (X) can suppress elution of e.g. Mn from the particles (1) when contacted with a decomposition product of an electrolyte at the time of charging (oxidation reaction) under a high voltage, and therefore Al and element (X) are preferably present as a compound which is not corroded by the decomposition product (such as hydrogen fluoride (HF)).

Among them, a compound containing Al (hereinafter referred to as a compound (a)) may, for example, be an oxide such as Al₂O₃, a hydroxide such as Al(OH)₃, a fluoride such as AlF₃, an oxyhydroxide such as AlOOH or an oxyfluoride such as AlOF. Further, a compound containing element (X) (hereinafter referred to as a compound (b)) may, for example, be Y₂O₃, Gd₂O₃, Er₂O₃, Y(OH)₃, Gd(OH)₃, Er(OH)₃, YF₃, GdF₃, ErF₃, YOOH, GdOOH, ErOOH, YOF, GdOF or ErOF.

In the particles (2), Al or element (X) is not limited to one present as the compound (α) or the compound (b) as mentioned above, but may be present as a composite compound of Al and element (X), specifically as e.g. AlYO₃, AlGdO₃ or AlErO₃.

The cathode active material of the present invention is preferably composed of the particles (2) wherein Al₂O₃ and at least one member selected from the group consisting of Y₂O₃, Gd₂O₃ and Er₂O₃ are present on the surface of the particles (1).

The molar amount of Al in the particles (2) is preferably from 0.001 to 0.05 time, more preferably from 0.005 to 0.04 time, particularly preferably from 0.01 to 0.03 time, the total molar amount of the transition metal element of the particles (1).

When the molar amount of Al contained in the particles (2) is at least 0.001 time the total molar amount of the transition metal element, it is possible to suppress elution of e.g. Mn from the particles (1) at the time of charging or discharging, whereby it is possible to obtain excellent cycle characteristics. On the other hand, if an excess amount of Al is contained therein, a resistance component originated from Al tends to be formed on the surface of the particles (1), whereby an average discharge voltage may not sufficiently be increased. When the molar amount of Al contained in the particles (2) is at most 0.05 time the total molar amount of the transition metal element, it is possible to suppress production of the resistance component on the surface of the particles (1), whereby it is possible to obtain excellent cycle characteristics.

The total molar amount of element (X) in the particles (2) is preferably from 0.0005 to 0.015 time, more preferably from 0.001 to 0.01 time, particularly preferably from 0.001 to 0.005 time, the total molar amount of the transition metal element, from the viewpoint of suppressing reduction of an average discharge voltage or a discharge capacity after charge and discharge, thereby to obtain excellent cycle characteristics.

When the total molar amount of element (X) contained in the particles (2) is from 0.0005 to 0.015 time the total molar amount of the transition metal element, it is possible to suppress elution of e.g. Mn from the particles (1) at the time of charging or discharging, and at the same time it is possible to suppress production of a resistance component on the surface of the particles (1), whereby it is possible to obtain excellent cycle characteristics.

The total molar amount of element (X) in the particles (2) is preferably from 0.01 to 1.0 time, more preferably from 0.03 to 0.8 time, particularly preferably from 0.1 to 0.5 time, the molar amount of Al, from the viewpoint of obtaining excellent cycle characteristics.

When the total molar amount of element (X) in the particles (2) is at least 0.01 time the molar amount of Al, a resistance component originated from Al does not tend to be formed on the surface of the particles (1), whereby it is possible to obtain a high average discharge voltage. Further, when element (X) is at most 1.0 time the molar amount of Al, it is possible to further suppress elution of e.g. Mn from the particles (1) at the time of charging or discharging, and at the same time it is possible to obtain excellent cycle characteristics.

The amount (molar ratio) of Al, the amount (molar ratio) of element (X) and the amount (molar ratio) of the above transition metal element, present in the particles (2), can be measured by dissolving the particles (2) as a cathode active material in an acid and carrying out ICP (high frequency inductively-coupled plasma) measurement.

Here, in a case where the amount of Al, the amount of element (X) and the amount of the above transition metal element cannot be obtained by means of the ICP measurement, the above-mentioned proportions (molar ratios) may be calculated based on the amount of the compound (α) containing Al, the amount of the compound (8) containing element (X) and the amount of the particles (1) in the after-mentioned production.

The shape of the particles (2) may be any of a spherical-form, a film-form, a fiber-form, an agglomerated form, etc. The average particle size (D50) of the particles (2) measured by means of a laser scattering particle size distribution measuring apparatus is preferably from 3 to 30 μm, more preferably from 4 to 25 μm, particularly preferably from 5 to 20 μm.

In the particles (2), it is possible to evaluate whether Al and element (X) are present on the surface of the particles (1) by, for example, cutting the particles (2), and subjecting the cross-sectional area to compositional analysis by means of energy dispersive X-ray microanalyzer (TEM-EDX).

Further, it is possible to confirm that Al and element (X) are present on the surface of the particles (1) by analyzing the particles (2) by means of X-ray photoelectron spectroscopy.

In the cathode active material for a lithium ion secondary battery of the present invention, the compound (α) or the compound (b) is preferably a compound which is not corroded by e.g. HF at the time of charging (oxidation reaction) under a high voltage, but the compound (α) or the compound (b) may be reacted with a decomposition product such as HF produced from an electrolyte to form a fluoride such as AlF₃ or YF₃ which is not corroded by e.g. HF on the surface of the particles (2). Even in the case of such a fluoride, when it is formed on the surface of the particles (2), it is possible to reduce such a proportion that the particles (1) are in contact with an electrolyte. As a result, it is considered that erosion of the surface of the particles (1) by a decomposition product of an electrolyte and accompanying elution of the transition metal element such as Mn from the particles (1) to the electrolyte, can be suppressed. Accordingly, it is considered that a reduction in discharge capacity can be lowered even when a charge/discharge cycle is carried out under high voltage, whereby excellent cycle characteristics can be achieved.

Further, as in the cathode active material for a lithium ion secondary battery of the present invention, in the case of particles having prescribed components present on the surface, elements being present on the surface of the particles and elements constituting the particles (1) tend to be mutually dispersed so as to form a composite film between them. In the cathode active material for a lithium ion secondary battery of the present invention, Al and element (X) are present on the surface of the particles (2), and therefore these elements and transition metal elements such as Mn, Ni and Co constituting particles (1) are mutually dispersed, whereby a stable composite film is readily formed on the surface of the particles (1). As a result, it is considered that elution of e.g. Mn from the particles (1) can be easily suppressed at the time of charging and discharging, whereby excellent cycle characteristics can be obtained.

Further, in a case where Al is present alone on the surface of the particles (1), a resistance component originated from Al tends to be formed on the surface of the particles (1), whereby an average discharge voltage may not sufficiently be high. In the cathode active material for a lithium ion secondary battery of the present invention, not only Al but also element (X) are present on the surface of the particles (1), whereby decrease of a discharge capacity can be suppressed, and at the same time an average discharge voltage can be kept at a high level, after a charge/discharge cycle, even when a resistance component originated from Al is produced.

The process for producing a cathode active material for a lithium ion secondary battery of the present invention is not particularly limited, and for example, it can be produced by the following process.

### [Process for Producing Cathode Active Material for Lithium Ion Secondary Battery]

The process for producing a cathode active material for a lithium ion secondary battery of the present invention, comprises:

a first contact step of contacting particles (1) made of a lithium-containing composite oxide containing Li and at least one transition metal element selected from the group consisting of Ni, Co and Mn, with the following composition (1), a second contact step of contacting the above particles (1) with the following composition (2), and

a heating step of heating particles obtained by the above first contact step and the above second contact step:

composition (1): a solution or dispersion containing a compound (α) containing Al and a medium;

composition (2): a solution or dispersion containing a compound (β) containing at least one member (element (X)) selected from the group consisting of Y, Gd and Er, and a medium.

According to the production process of the present invention, it is possible to produce, with good productivity, the cathode active material for a lithium ion secondary battery of the present invention, excellent in the cycle characteristics even when charging is carried out under a high voltage. Now, the respective steps will be described.

### (Contact Step)

The first contact step is to contact particles (1) made of a lithium-containing composite oxide with a composition (1) having a compound (α) containing Al (hereinafter referred to as compound (α)) dissolved or dispersed in a medium. Further, the second contact step is to contact the above particles (1) with a composition (2) having a compound (β) containing element (X) (hereinafter referred to as compound (β)) dissolved or dispersed in a medium.

The composition (1) contains the compound (α) and a medium, and as the case requires, it may contain a pH-adjusting agent. The composition (2) contains the compound (β) and a medium, and as the case requires, it may contain a pH-adjusting agent.

The compound (α) may, for example, be aluminum nitrate, aluminum acetate, aluminum citrate, aluminum lactate, basic aluminum lactate or aluminum formate.

In the composition (1), the compound (α) is preferably aluminum lactate or basic aluminum lactate, since a high Al concentration is easily obtained and further a precipitated product is hardly produced even when pH of the composition (1) increases. Especially, when the particles (1) are the above-mentioned compound (ii), since pH of the composition (1) contacted with the particles (1) increases, the composition (1) preferably contains aluminum lactate or basic aluminum lactate which is free from the production of a precipitated product even when pH increases to 11 or more.

Moreover, the composition (1) using aluminum lactate or basic aluminum lactate as the compound (α) is preferred from the following reasons:

<1> When such a composition (1) is contacted with the particles (1), it hardly becomes excessively acidic, and therefore dissolution of a transitional metal element in the particles (1) can be suppressed.

<2> No noxious gas such as a nitrogen oxide produces at the time of the after-mentioned heat treatment.

<3> In the particles (2) after the heating step, a component (harmful component) as hindrance to battery performance, such as a chloride radical hardly remains.

As a medium of the composition (1), it is preferred to use one containing water in view of the stability and the reactivity of the compound (α).

As the medium, a mixture of water and a water soluble alcohol and/or polyol may suitably be used. The water soluble alcohol may be methanol, ethanol, 1-propanol or 2-propanol. The polyol may be ethylene glycol, propylene glycol, diethylene glycol, dipropylene glycol, polyethylene glycol, butanediol or glycerol.

The total content of the water soluble alcohol and polyol contained in the medium is preferably from 0 to 20 mass %, more preferably from 0 to 10 mass % to the entire amount of the medium. The medium particularly preferably consists solely of water since it is excellent in the safety, the environment, the handling efficiency and the cost.

The pH adjusting agent is preferably one which is volatilized or decomposed at the time of heating. Specifically, it is preferably an organic acid such as acetic acid, citric acid, lactic acid or formic acid, or ammonia. When such a pH adjusting agent which is volatilized or decomposed is used, impurities hardly remain, whereby favorable battery characteristics are likely to be obtained.

The pH of the composition (1) is preferably from 3 to 12, more preferably from 3.5 to 12, particularly preferably from 4 to 10. When the pH is within a range of from 3 to 12, elution of Li and the transition metal element from the particles (1) tends to be small when the particles (1) are contacted with the composition (1) and the composition (2), whereby favorable battery characteristics are likely to be obtained.

The concentration of the compound (α) in the composition (1) is preferably higher, since it is necessary to remove the medium by heating in the subsequent step. However, if the concentration is too high, the viscosity of the composition (1) becomes excessively high, and therefore it tends to be difficult to uniformly mix the particles (1) with the composition (1). Accordingly, the concentration of the compound (α) in the composition (1) is preferably from 1 to 30 mass %, more preferably from 4 to 20 mass % as calculated as Al₂O₃ of Al contained in the compound (α).

It is preferred that the composition (1) is prepared while heating the mixture of the compound (α) and the medium, as the case requires. A heating temperature at the time of preparing the composition (1) is preferably from 40 to 80° C., more preferably from 50 to 70° C. By the heating, the compound (α) tends to easily be dissolved in the medium, whereby a stable solution is readily obtained.

The composition (1) is not particularly limited so long as the compound (α) is dissolved or dispersed in the medium, but an aqueous solution is particularly preferred since the particles (1) and the composition (1) can uniformly be mixed.

The compound (β) may be an inorganic salt such as a nitrate, sulfate or chloride, an organic salt such as a lactate, acetate, citrate or formate, or an organic complex, of element (X).

Among them, a nitrate, lactate, acetate, citrate or formate is preferred in that the solubility in the medium such as water is high, and components as a hindrance to the battery performance hardly remain in the particles (2) after the heating step.

The compound (β) may specifically be yttrium nitrate, yttrium lactate, yttrium formate, yttrium citrate, yttrium acetate, erbium nitrate, erbium lactate, erbium formate, erbium citrate, erbium acetate, gadolinium nitrate, gadolinium lactate, gadolinium formate, gadolinium citrate or gadolinium acetate.

The compound (β) is particularly preferably yttrium lactate, erbium lactate or gadolinium lactate from the same reason as in the case of using aluminum lactate as the compound (α).

Preparation of the composition (2) may be carried out in the same manner as the composition (1), and the medium and the pH adjusting agent may be the same as the composition (1). Further, preferred ranges of the pH value and the concentration of the compound (β) in the composition (2) are the same as the composition (1). Here, the concentration of the compound (β) in the composition (2) is one represented as calculated as an oxide of element (X) contained in each compound (β).

In the first contact step in the present invention, a spray coating method or a dipping method may be used as a method of contacting the particles (1) and the composition (1).

The dipping method needs a step of removing a large amount of the medium by filtration or evaporation after dipping of the particles (1) in the composition (1), whereby the process tends to be cumbersome. On the other hand, the spray coating method needs no step of removing the medium by e.g. filtration, and therefore a production process is simple and excellent in productivity. Further, the above first contact step is preferably carried out by a spray coating method since it is possible to easily obtain covered particles having the surface of the particles (1) uniformly covered with the compound (α).

As a method of contacting the particles (1) with the composition (1), it is preferred to contact the composition (1) with the particles (1) while the particles (1) are stirred and mixed, whereby the surface of the particles (1) will more uniformly be covered with the compound (α).

As the stirring/mixing apparatus, it is possible to use a stirring machine having a low shearing force, such as a drum mixer or a solid air.

In the first contact step of the present invention, it is preferred to carry out drying after the particles (1) are contacted with the composition (1). In a case where the contacting is carried out by the spray coating method, the spray coating and the drying may be carried out alternately, or, the drying may be carried out simultaneously with the spray coating. The drying temperature is preferably from 40 to 200° C., more preferably from 60 to 150° C.

In a case where the particles (1) become agglomerates by contacting the particles (1) with the composition (1) and drying them, it is preferred to pulverize the agglomerates. The spraying amount of the composition (1) in the spray coating method is preferably from 0.005 to 0.1 g/min, per 1 g of the particles (1).

In the second contact step in the present invention, the contacting the particles (1) with the composition (2) may be carried out in the same manner as in the above first contact step.

In the production process of the present invention, the first contact step and the second contact step may be simultaneously carried out, or the first contact step and the second contact step may be separately carried out so that the composition (1) and the composition (2) may be separately contacted with the particles (1).

In a case where the composition (1) and the composition (2) are separately contacted with the particles (1), as the order of the contact, the composition (1) may be contacted with the particles (1) and then the composition (2) may be contacted, the composition (2) is contacted with the particles (1) and then the composition (1) is contacted, or the composition (1) and the composition (2) may be contacted alternately a plurality of times.

In a case where the first contact step and the second contact step are simultaneously carried out, the composition (1) and the composition (2) may be contacted with the particles (1) simultaneously, or a mixture of the composition (1) and the composition (2) may be contacted with the particles (1).

The total amount of the composition (1) and the composition (2) to be in contact with the particles (1) is preferably from 1 to 50 mass %, more preferably from 2 to 40 mass %, particularly preferably from 3 to 30 mass %, to the particles (1). When the total amount of the composition (1) and the composition (2) to be in contact with the particles (1) is within the above range, the surface of the particles (1) can uniformly be covered with the compound (α) and the compound (β), and further at the time of spray coating the composition (1) and the composition (2) to the particles (1), the particles (1) are hardly agglomerated, and agitation can be smoothly carried out.

The production process of the present invention has a heating step of heating particles (hereinafter referred to as covered particles) obtained by the first contact step and the second contact step. By heating the covered particles, it is possible to form e.g. the compound (a) or the compound (b) as mentioned above, from the compound (α) or the compound (β) covering the surface of the particles (1). Further, by the heating, it is possible to remove volatile impurities such as water, organic components, etc.

The heating of the covered particles is preferably carried out in an oxygen-containing atmosphere. Further, the heating temperature is preferably from 300 to 550° C., more preferably from 330 to 520° C., particularly preferably from 360 to 480° C. When the heating temperature is at least 300° C., e.g. the compound (a) or the compound (b) can easily be produced from e.g. the compound (α) or the compound (β), and further volatile impurities such as remaining water in the particles (2) can be reduced, whereby it is possible to further suppress adverse influences on the cycle characteristics. Further, when the heating temperature is at most 550° C., it is possible to suppress diffusion of elements contained in e.g. the compound (a) or the compound (b) to the inside of the particles (1), or excessive reaction with Li or the transition metal element in the particles (1).

The heating time is preferably from 0.1 to 24 hours, more preferably from 0.5 to 15 hours, particularly preferably from 1 to 10 hours. When the heating time is within the above range, it is possible to efficiently form the cathode active material of the present invention.

The pressure at the time of the heating is not particularly limited, and ordinary pressure or elevated pressure is preferred, and ordinary pressure is particularly preferred.

### [Cathode for Lithium Ion Secondary Battery]

The cathode for a lithium ion secondary battery of the present invention has a cathode active material layer comprising the cathode active material for a lithium ion secondary battery of the present invention, an electrically conductive material and a binder, formed on a cathode current collector.

As a method for producing such a cathode for a lithium ion secondary battery, for example, the above cathode active material, an electrically conductive material and a binder are dissolved or dispersed in a medium to obtain a slurry, or the above cathode active material, an electrically conductive material and a binder are kneaded with a medium to obtain a kneaded product. The resulting slurry or kneaded product is supported on a cathode current collector by e.g. coating thereby to produce the cathode for a lithium ion secondary battery.

The electrically conductive material may, for example, be a carbon black such as acetylene black, graphite or Ketjenblack.

The binder may, for example, be a fluororesin such as polyvinylidene fluoride or polytetrafluoroethylene, a polyolefin such as polyethylene or polypropylene, an unsaturated bond-containing polymer or copolymer such as styrene/butadiene rubber, isoprene rubber or butadiene rubber, or an acrylic acid type polymer or copolymer such as an acrylic acid copolymer or methacrylic acid copolymer. The cathode current collector may, for example, be an aluminum foil or an stainless steel foil.

### [Lithium Ion Secondary Battery]

The lithium ion secondary battery of the present invention comprises the above-described cathode for a lithium ion secondary battery of the present invention, an anode and a non-aqueous electrolyte.

The anode comprises an anode current collector and an anode active material layer containing an anode active material, formed on the anode current collector.

The anode can be produced, for example, in such a manner that an anode active material is mixed with an organic solvent to prepare a slurry, and the prepared slurry is applied to an anode current collector, followed by drying and pressing.

As the anode current collector, a metal foil such as a nickel foil or a cupper foil may, for example, be used.

The anode active material may be any material so long as it is capable of absorbing and desorbing lithium ions at a relatively low potential. For example, it is possible to employ a lithium metal, a lithium alloy, a lithium compound, a carbon material, an oxide composed mainly of a metal element in Group 14 or 15 of the periodic table, a carbon compound, a silicon carbide compound, a silicon oxide compound, titanium sulfide, a boron carbide compound, etc.

As the carbon material as the anode active material, it is possible to use, for example, non-graphitizable carbon, artificial graphite, natural graphite, thermally decomposed carbon, cokes such as pitch coke, needle coke, petroleum coke, etc., graphites, glassy carbons, an organic polymer compound fired product obtained by firing and carbonizing a phenol resin, furan resin, etc. at a suitable temperature, carbon fibers, activated carbon, carbon blacks, etc.

The metal in Group 14 of the periodic table may, for example, be silicon or tin, and most preferred is silicon.

As another material which can be used as the anode active material, it is possible to use, for example, an oxide such as iron oxide, ruthenium oxide, molybdenum oxide, tungsten oxide, titanium oxide, tin oxide, etc. or a nitride.

As a non-aqueous electrolyte, it is possible to use a non-aqueous electrolyte solution having an electrolyte salt dissolved in an organic solvent, a solid electrolyte containing an electrolyte salt, a polymer electrolyte, a solid or geled electrolyte having an electrolyte salt mixed or dissolved in e.g. a polymer compound, etc.

As the organic solvent, it is possible to use a conventional one known as an organic solvent for a non-aqueous electrolytic solution, and for example, it is possible to use propylene carbonate, ethylene carbonate, diethyl carbonate, dimethyl carbonate, 1,2-dimethoxyethane, 1,2-diethoxyethane, γ-butyrolactone, diethyl ether, sulfolane, methyl sulfolane, acetonitrile, an acetic acid ester, a butyric acid ester, a propionic acid ester, etc. Particularly, from the viewpoint of the voltage stability, it is preferred to use a cyclic carbonate such as propylene carbonate, or a chain-structured carbonate such as dimethyl carbonate or diethyl carbonate. Further, such organic solvents may be used alone, or two or more of them may be used as mixed.

The solid electrolyte may be any material so long as it has lithium ion conductivity, and for example, either one of an inorganic solid electrolyte and a polymer electrolyte may be used.

As the inorganic solid electrolyte, it is possible to use lithium nitride, lithium iodide, etc.

As the polymer electrolyte, it is possible to use an electrolyte salt and a polymer compound which dissolves the electrolyte salt. And, as such a polymer compound which dissolves an electrolyte salt, it is possible to use an ether type polymer such as polyethylene oxide) or a crosslinked product thereof, a poly(methacrylate) ester type polymer, an acrylate type polymer, etc. alone or as mixed.

The matrix for the geled electrolyte may be any one so long as it is geled upon absorption of the above non-aqueous electrolyte, and various polymer compounds may be employed.

Further, as the polymer compound to be used for the geled electrolyte, it is possible to use, for example, a fluorinated polymer compound such as poly(vinylidene fluoride) or poly(vinylidene fluoride-co-hexafluoropropylene); polyacrylonitrile or a copolymer of polyacrylonitrile; or an ether type polymer compound such as a polyethylene oxide, or a copolymer or cross-linked product of polyethylene oxide.

As the monomer to be copolymerized with the copolymer may, for example, be polypropylene oxide, methyl methacrylate, butyl methacrylate, methyl acrylate or butyl acrylate.

As the matrix for the geled electrolyte, it is particularly preferred to use a fluorinated polymer compound among the above-mentioned polymers, from the viewpoint of the stability against the redox reaction.

As the electrolyte salt to be used in the above-described various electrolytes, any one of those commonly used for batteries of this type may be used. As such an electrolyte salt, for example, LiClO₄, LiPF₆, LiBF₄, CH₃SO₃Li, etc. may be used.

The shape of the lithium ion secondary battery of the present invention may be suitably selected depending on the intended use from e.g. a coin-shape, a sheet-form (film-form), a folded shape, a wound cylinder with bottom, a button shape, etc.

### EXAMPLES

Now, the present invention will be described in detail with reference to Examples, but it should be understood that the present invention is by no means restricted by the Examples.

### <Synthesis of Lithium-Containing Composite Oxide>

1,245.9 g of distilled water was added to a mixture of 140.6 g of nickel(II) sulfate hexahydrate, 131.4 g cobalt(II) sulfate heptahydrate and 482.2 g of manganese(II) sulfate pentahydrate to obtain raw material solution. 320.8 g of distilled water was added to 79.2 g of ammonium sulfate to obtain an ammonia solution. Further, 600 g of distilled water was added to 400 g of sodium hydroxide to obtain a pH-adjusting solution.

Then, into a 2 L (liter) baffle-equipped glass reactor, a solution obtained by adding 1920.8 g of distilled water to 79.2 g of ammonium sulfate was put and heated to 50° C. by a mantle heater. Further, the pH-adjusting solution was added to bring the pH to be 11.0. While stirring the solution in the reactor by anchor-type stirring vanes, the raw material solution was added at a rate of 5.0 g/min, and the ammonia solution was added at a rate of 1.0 g/min, to have a composite hydroxide of nickel, cobalt and manganese precipitated. During the addition of the raw material solution, the pH-adjusting solution was added to maintain the pH in the reactor to be 11.0. Further, in order to prevent oxidation of the precipitated composite hydroxide, nitrogen gas was introduced into the reactor at a flow rate of 0.5 L/min.

In order to remove impurity ions from the obtained composite hydroxide, pressure filtration and dispersion to distilled water were repeated for washing. The washing was terminated when the electrical conductivity of the filtrate became less than 25 μS/cm, followed by drying at 120° C. for 15 hours to obtain a precursor. The contents of nickel, cobalt and manganese in the precursor obtained were measured by ICP by means of a plasma emission spectrometry (manufactured by SII NanoTechnology Inc., Type Name: SPS3100H) and found to be 11.6 mass %, 10.5 mass % and 42.3 mass %, respectively. The molar ratio of nickel:cobalt:manganese was found to be 0.172:0.156:0.672.

Then, 20 g of this precursor and 12.6 g of lithium carbonate having a lithium content of 26.9 mol/kg were mixed and fired at 900° C. for 12 hours in an oxygen-containing atmosphere to obtain a lithium-containing composite oxide (A).

The composition of the obtained lithium-containing composite oxide (A) was Li_{1.2}(Ni_{0.172}Co_{0.156}Mn_{0.672})_{0.8}O₂. The lithium-containing composite oxide (A) had an average particle size D50 of 5.9 μm, and a specific surface area of 2.6 m²/g as measured by means of a nitrogen adsorption BET (Brunauer, Emmett, Teller) method.

### Example 1

To 7.02 g of a basic aluminum lactate aqueous solution having an aluminum content of 8.5 mass % as calculated as Al₂O₃, 2.98 g of distilled water was added to prepare an aluminum lactate aqueous solution (5.97 mass %) as composition (1). Then, 9.63 g of distilled water was added to 0.37 g of yttrium(III) nitrate hexahydrate to prepare aqueous yttrium nitrate solution (1.09 mass %) as a composition (2).

To 10 g of the lithium-containing composite oxide (A), 1.0 g of aluminum lactate aqueous solution was spray coated while the lithium-containing composite oxide (A) was stirred. Then, 0.6 g of aqueous yttrium nitrate solution was spray coated while the lithium-containing composite oxide (A) was stirred to obtain covered particles of the lithium-containing composite oxide (A).

Then, the resulting covered particles were dried at 90° C. for 2 hours and then heated at 400° C. for 8 hours in an oxygen-containing atmosphere to obtain a cathode active material (A).

The molar amount of Al and the molar amount of yttrium (Y), erbium (Er), gadolinium (Gd), cerium (Ce) or lanthanoid (La), based on the total amount of transition metal elements (nickel, cobalt and manganese) of the lithium-containing composite oxide (A), contained in the cathode active material (A) obtained and cathode active materials (B) to (Q) obtained in the after-mentioned Examples 2 to 8 and Comparative Examples 1 to 9, are respectively shown in Table 3.

The molar amount of Al, Y, Er, Gd, La or Ce in each of the following Examples 1 to 8 and Comparative Examples 1 to 9 is one calculated based on each charged amount.

### Example 2

The cathode active material (B) was obtained in the same manner as in Example 1 except that the amount of aqueous yttrium nitrate solution to be spray coated on the surface of the lithium-containing composite oxide (A) was changed from 0.6 g to 1.2 g.

### Example 3

The cathode active material (C) was obtained in the same manner as in Example 1 except that an aqueous yttrium nitrate solution (4.42 mass %) prepared by adding 8.50 g of distilled water to 1.50 g of yttrium(III) nitrate hexahydrate was used as a composition (2).

### Example 4

The cathode active material (D) was obtained in the same manner as in Example 3 except that the amount of an aqueous yttrium nitrate solution to be spray coated on the surface of the lithium-containing composite oxide (A) was changed from 0.6 g to 1.2 g.

### Example 5

The cathode active material (E) was obtained in the same manner as in Example 1 except that an aqueous erbium nitrate solution (4.49 mass %) prepared by adding 8.96 g of distilled water to 1.04 g of erbium(III) nitrate pentahydrate was used as the composition (2), and the amount of the composition (2) (erbium nitrate) aqueous solution to be spray coated on the surface of the lithium-containing composite oxide (A) was changed to 1.0 g.

### Example 6

The cathode active material (F) was obtained in the same manner as in Example 5 except that an aqueous gadolinium nitrate solution (4.26 mass %) prepared by adding 8.94 g of distilled water to 1.06 g of gadolinium(III) nitrate hexahydrate was used as the composition (2).

### Example 7

The cathode active material (G) was obtained in the same manner as in Example 5 except that an aqueous aluminum lactate solution (2.98 mass %) prepared by adding 6.49 g of distilled water to 3.51 g of a basic aluminum lactate aqueous solution having an aluminum content of 8.5 mass % as calculated as Al₂O₃ was used as the composition (1), and that an aqueous gadolinium nitrate solution (10.6 mass %) prepared by adding 7.36 g of distilled water to 2.64 g of gadolinium(III) nitrate hexahydrate was used as the composition (2).

### Example 8

The cathode active material (H) was obtained in the same manner as in Example 7 except that an aqueous yttrium nitrate solution (6.61 mass %) prepared by adding 7.76 g of distilled water to 2.24 g of yttrium(III) nitrate hexahydrate was used as the composition (2).

### Comparative Example 1

The cathode active material (I) was obtained in the same manner as in Example 1 except that the composition (1) and the composition (2) were not spray coated to the lithium-containing composite oxide (A).

### Comparative Example 2

The cathode active material (J) was obtained in the same manner as in Example 1 except that the composition (2) was not spray coated.

### Comparative Example 3

The cathode active material (K) was obtained in the same manner as in Comparative Example 2 except that the amount of an aqueous aluminum lactate solution spray coated on the surface of the lithium-containing composite oxide (A) was changed from 1.0 g to 2.0 g.

### Comparative Example 4

The cathode active material (L) was obtained in the same manner as in Example 8 except that the composition (1) was not spray coated.

### Comparative Example 5

The cathode active material (M) was obtained in the same manner as in Comparative Example 4 except that the amount of the aqueous yttrium nitrate solution spray coated on the surface of the lithium-containing composite oxide (A) was changed from 1.0 g to 2.0 g.

### Comparative Example 6

The cathode active material (N) was obtained in the same manner as in Comparative Example 5 except that an aqueous erbium nitrate solution (b) (11.2 mass %) prepared by adding 7.40 g of distilled water to 2.60 g of erbium(III) nitrate pentahydrate was used as the composition (2).

### Comparative Example 7

The cathode active material (0) was obtained in the same manner as in Comparative Example 5 except that an aqueous gadolinium nitrate solution (10.6 mass %) prepared by adding 7.36 g of distilled water to 2.64 g of gadolinium(III) nitrate hexahydrate was used as the composition (2).

### Comparative Example 8

The cathode active material (P) was obtained in the same manner as in Example 5 except that an aqueous lanthanum nitrate solution (3.82 mass %) prepared by adding 8.99 g of distilled water to 1.01 g of lanthanum(III) nitrate hexahydrate was used instead of the aqueous erbium nitrate solution (composition (2)).

### Comparative Example 9

The cathode active material (Q) was obtained in the same manner as in Example 5 except that an aqueous cerium nitrate solution (3.84 mass %) prepared by adding 8.98 g of distilled water to 1.02 g of cerium(III) nitrate hexahydrate, was used instead of the aqueous erbium nitrate solution (composition (2)).

### [X-Ray Photoelectron Spectroscopic Analysis]

The cathode active materials (H), (I) and (L) obtained, and an yttrium oxide powder as a comparative sample were subjected to XPS wide spectrum measurement by using an X-ray spectroscopic apparatus (manufactured by ULVAC-PHI, Inc., PHI-5500), and from peaks of C1s, O1s, Al₂p, Mn2p, Co2p₃, Ni2p₃ and Y3d, the molar ratios of C, O, Al, Mn, Co, Ni and Y on the surface of the cathode active material were determined. Evaluation results are shown in Table 1. Here, in Table 1, “-” represents a case where no peak was detected.

Measurement conditions of XPS analysis were such that AlKα (provided with a monochrometer) was used as an X-ray source, a measurement area was adjusted to an area within a circle having a diameter of about 800 μm, and a pulse energy was controlled to 93.9 eV.

TABLE 1

| | C | O | Al | Mn | Co | Ni | Y |
|---|---|---|---|---|---|---|---|
| Cathode active material (H) | 12.4 | 65.6 | 8.9 | 5.5 | 2.3 | 1.2 | 4.1 |
| Cathode active material (I) | 11.4 | 62.7 | —(* | 14.9 | 7.5 | 3.5 | — |
| Cathode active material (L) | 19.1 | 62.7 | — | 8.1 | 2.5 | 1.6 | 6.0 |
| Yttrium oxide powder | 13.3 | 61.5 | — | — | — | — | 25.2 |

*)In Table 1, “—” represents a case where no peak was detected.

As is clear from Table 1, the concentrations of Al and Y were high at the surface of the cathode active material (H), and therefore it was confirmed that Al and Y were present on the surface of the cathode active material (H).

Likewise, the cathode active materials (A) to (G) are subjected to XPS wide spectrum measurement, whereby it is possible to confirm that Al and at least one member selected from the group consisting of Y, Gd and Er as coating materials are present on the surface of the cathode active material.

### [Production of Cathode Sheet]

One of the cathode active materials (A) to (Q) obtained in Examples 1 to 8 and Comparative Examples 1 to 9, acetylene black (electrically conductive material) as an electrically conductive material and a polyvinylidene fluoride solution (solvent; N-methylpyrrolidone) containing 12.0 mass % of polyvinylidene fluoride (binder), were mixed, and N-methylpyrrolidone was further added so that the solid content concentration in a slurry would be 30 mass % to prepare a slurry. At that time, the mass ratio of the cathode active material, acetylene black and polyvinylidene fluoride was made to be 80:10:10.

Then, the slurry was applied on one side of an aluminum foil (cathode current collector) having a thickness of 20 μm by means of a doctor blade, followed by drying at 120° C. and then by roll pressing twice to prepare a cathode sheet in Examples 1 to 8 and Comparative Examples 1 to 9. Here, cathode sheets obtained from the cathode active materials (A) to (Q) in Examples 1 to 8 and Comparative Examples 1 to 9 are designated as cathode sheets 1 to 17, respectively.

### [Production of Lithium Ion Secondary Battery]

Using as a cathode one of the cathode sheets 1 to 17 obtained as described above punched into a circle with a diameter of 18 mm, a stainless steel simple sealed cell type lithium ion secondary battery was assembled in an argon glove box.

Here, a metal lithium foil having a thickness of 500 μm was used as an anode, a stainless steel plate having a thickness of 1 mm was used as an anode current collector, and a porous polypropylene having a thickness of 25 μm was used as a separator.

Further, as an electrolytic solution, LiPF₆ at a concentration of 1 (mol/dm³)/EC (ethylene carbonate)+DEC (diethyl carbonate) (1:1) solution (which means a mixed solution having LiPF₆ as a solute dissolved in EC and DEC in a volume ratio (EC:DEC)=1:1) was used. Here, lithium ion secondary batteries employing the cathode sheets 1 to 17, respectively, are designated as batteries 1 to 17, respectively.

### [Evaluations of Lithium Ion Secondary Batteries]

With respect to the batteries 1 to 17 produced, the following evaluations were carried out.

### <Initial Capacity><Evaluation of Cycle Characteristics>

A charge/discharge cycle of charging to 4.6 V with a load current of 200 mA per 1 g of the cathode active material and then discharging to 2.5 V with a load current of 100 mA per 1 g of the cathode active material, was repeated 100 times. At that time, the discharge capacity in the fifth charge/discharge cycle is taken as “initial capacity”, the discharge capacity in the 100th charge/discharge cycle is taken as “discharge capacity after cycle” and an average discharge voltage in the 100th charge/discharge cycle is taken as “average voltage after cycle”.

The type, concentration and spray amount (g) of compounds used in the production of the cathode active materials (A) to (Q) are shown in Table 2. With respect to batteries 1 to 17 in Examples 1 to 8 and Comparative Examples 1 to 9, the results of evaluation of the initial capacity, the discharge capacity after cycle and the average voltage after cycle, and the molar amount of Al and the molar amount of element (X) to the total amount of transition metal elements of the lithium-containing composite oxide (A), and the molar amount of element (X) to Al are shown in Table 3.

TABLE 2

| | | | | | | Concentration | |
|---|---|---|---|---|---|---|---|
| | | Concentration | | | | of compound | |
| | | of aluminum | | | | (β) and other | |
| | Cathode active | lactate | Spray amount | | Other | compound | Spray amount |
| | material | [mass %] | [g] | Compound (β) | compound | [mass %] | [g] |
| Ex. 1 | (A) | 5.97 | 1.0 | Yttrium nitrate | — | 1.09 | 0.6 |
| Ex. 2 | (B) | 5.97 | 1.0 | Yttrium nitrate | — | 1.09 | 1.2 |
| Ex. 3 | (C) | 5.97 | 1.0 | Yttrium nitrate | — | 4.42 | 0.6 |
| Ex. 4 | (D) | 5.97 | 1.0 | Yttrium nitrate | — | 4.42 | 1.2 |
| Ex. 5 | (E) | 5.97 | 1.0 | Erbium nitrate | — | 4.49 | 1.0 |
| Ex. 6 | (F) | 5.97 | 1.0 | Gadolinium nitrate | — | 4.26 | 1.0 |
| Ex. 7 | (G) | 2.98 | 1.0 | Gadolinium nitrate | — | 10.6 | 1.0 |
| Ex. 8 | (H) | 2.98 | 1.0 | Yttrium nitrate | — | 6.61 | 1.0 |
| Comp. Ex. 1 | (I) | — | — | — | — | — | — |
| Comp. Ex. 2 | (J) | 5.97 | 1.0 | — | — | — | — |
| Comp. Ex. 3 | (K) | 5.97 | 2.0 | — | — | — | — |
| Comp. Ex. 4 | (L) | — | — | Yttrium nitrate | — | 6.61 | 1.0 |
| Comp. Ex. 5 | (M) | — | — | Yttrium nitrate | — | 6.61 | 2.0 |
| Comp. Ex. 6 | (N) | — | — | Erbium nitrate | — | 11.2 | 2.0 |
| Comp. Ex. 7 | (O) | — | — | Gadolinium nitrate | — | 10.6 | 2.0 |
| Comp. Ex. 8 | (P) | 5.97 | 1.0 | — | Lanthanum | 3.82 | 1.0 |
| | | | | | nitrate | | |
| Comp. Ex. 9 | (Q) | 5.97 | 1.0 | — | Cerium | 3.84 | 1.0 |
| | | | | | nitrate | | |

TABLE 3

| | | | | | Molar amount of | | | | Average |
|---|---|---|---|---|---|---|---|---|---|
| | | | | Molar amount of | element (X) or | Molar amount of | | Discharge | discharge |
| | Cathode | Type of | Type of | Al | other element | element (X) or | Initial | capacity | capacity |
| | active | element | other | (to transition | (to transition | other element | capacity | after cycle | after cycle |
| | material | (X) | element | metal element) | metal element) | (to Al) | [mAh/g] | [mAh/g] | [V] |
| Ex. 1 | (A) | Y | — | 0.0125 | 0.0006 | 0.048 | 206 | 201 | 3.27 |
| Ex. 2 | (B) | Y | — | 0.0125 | 0.0013 | 0.104 | 204 | 203 | 3.30 |
| Ex. 3 | (C) | Y | — | 0.0125 | 0.0025 | 0.200 | 204 | 207 | 3.31 |
| Ex. 4 | (D) | Y | — | 0.0125 | 0.0050 | 0.400 | 202 | 212 | 3.33 |
| Ex. 5 | (E) | Er | — | 0.0125 | 0.0025 | 0.200 | 207 | 202 | 3.31 |
| Ex. 6 | (F) | Gd | — | 0.0125 | 0.0025 | 0.200 | 205 | 201 | 3.32 |
| Ex. 7 | (G) | Gd | — | 0.0063 | 0.0063 | 1.000 | 195 | 195 | 3.33 |
| Ex. 8 | (H) | Y | — | 0.0063 | 0.0063 | 1.000 | 196 | 195 | 3.33 |
| Comp. | (I) | — | — | — | — | — | 215 | 155 | 3.13 |
| Ex. 1 | | | | | | | | | |
| Comp. | (J) | — | — | 0.0125 | — | — | 214 | 190 | 3.25 |
| Ex. 2 | | | | | | | | | |
| Comp. | (K) | — | — | 0.0250 | — | — | 204 | 192 | 3.24 |
| Ex. 3 | | | | | | | | | |
| Comp. | (L) | Y | — | — | 0.0063 | — | 205 | 187 | 3.27 |
| Ex. 4 | | | | | | | | | |
| Comp. | (M) | Y | — | — | 0.0125 | — | 210 | 191 | 3.27 |
| Ex. 5 | | | | | | | | | |
| Comp. | (N) | Er | — | — | 0.0125 | — | 203 | 186 | 3.28 |
| Ex. 6 | | | | | | | | | |
| Comp. | (O) | Gd | — | — | 0.0125 | — | 204 | 192 | 3.29 |
| Ex. 7 | | | | | | | | | |
| Comp. | (P) | — | La | 0.0125 | 0.0025 | 0.200 | 204 | 175 | 3.28 |
| Ex. 8 | | | | | | | | | |
| Comp. | (Q) | — | Ce | 0.0125 | 0.0025 | 0.200 | 205 | 163 | 3.19 |
| Ex. 9 | | | | | | | | | |

From Table 3, all of lithium batteries 1 to 8 in Examples have a discharge capacity after cycle of at least 195 mAh/g and further have an average discharge voltage after cycle of at least 3.27 V, and thus have excellent cycle characteristics.

Among them, batteries 2 to 6 which have a total molar amount of at least one metal element selected from the group consisting of Y, Gd and Er to the molar amount of Al of from 0.1 to 0.5 time have a discharge capacity after cycle of at least 200 mAh/g and an average discharge voltage after cycle of at least 3.30 V, and especially have excellent cycle characteristics.

### INDUSTRIAL APPLICABILITY

According to the present invention, it is possible to obtain a cathode active material for a lithium ion secondary battery, which has a high discharge capacity per unit mass and which is excellent in cycle characteristics. This cathode active material is useful for a cathode for a small sized light weight lithium ion secondary battery for electronic instruments such as cell phones or for vehicles, or a lithium ion secondary battery using such a cathode.

This application is a continuation of PCT Application No. PCT/JP2013/060873, filed on Apr. 10, 2013, which is based upon and claims the benefit of priority from Japanese Patent Application No. 2012-090395 filed on Apr. 11, 2012. The contents of those applications are incorporated herein by reference in their entireties.

What is claimed is:

1. A cathode active material for a lithium ion secondary battery, characterized in that Al and at least one member selected from the group consisting of Y, Gd and Er are present on the surface of particles (1) made of a lithium-containing composite oxide containing Li and at least one transition metal element selected from the group consisting of Ni, Co and Mn.

2. The cathode active material for a lithium ion secondary battery according to claim 1, wherein the lithium-containing composite oxide is represented by the following formula (2-1):
Li(LiₓMn_{y}Me_{z})OₚF_{q} (2-1)
wherein Me is at least one element selected from the group consisting of Co and Ni, 0.11≦x≦0.22, 0.55≦y/(y+z)<0.75, x+y+z=1, 1.9<p<2.1, and 0<q<0.1.

3. The cathode active material for a lithium ion secondary battery according to claim 1, wherein the molar amount of the above Al is from 0.001 to 0.05 time the total molar amount of the transition metal element.

4. The cathode active material for a lithium ion secondary battery according to claim 1, wherein the total molar amount of at least one member selected from the group consisting of Y, Gd and Er is from 0.0005 to 0.015 time the total molar amount of the transition metal element.

5. The cathode active material for a lithium ion secondary battery according to claim 1, wherein the total molar amount of at least one member selected from the group consisting of the above Y, Gd and Er is from 0.01 to 1.0 time the molar amount of the above Al.

6. The cathode active material for a lithium ion secondary battery according to claim 1, which is composed of particles (2) wherein Al₂O₃ and at least one member selected from the group consisting of Y₂O₃, Gd₂O₃ and Er₂O₃ are present on the surface of the particles (1) made of the lithium-containing composite oxide.

7. A process for producing a cathode active material for a lithium ion secondary battery, which comprises:
a first contact step of contacting particles (1) made of a lithium-containing composite oxide containing Li and at least one transition metal element selected from the group consisting of Ni, Co and Mn, with the following composition (1),
a second contact step of contacting the above particles (1) with the following composition (2), and
a heating step of heating particles obtained by the above first contact step and the above second contact step:
composition (1): a solution or dispersion containing a compound (α) containing Al and a medium;
composition (2): a solution or dispersion containing a compound (β) containing at least one member selected from the group consisting of Y, Gd and Er, and a medium.

8. The process for producing a cathode active material for a lithium ion secondary battery according to claim 7, wherein the above compound (α) is at least one member selected from the group consisting of aluminum lactate, aluminum acetate, basic aluminum lactate and aluminum nitrate.

9. The process for producing a cathode active material for a lithium ion secondary battery according to claim 7, wherein the above compound (β) is at least one member selected from the group consisting of a lactate, acetate, citrate, formate and nitrate of Y, Gd or Er.

10. The process for producing a cathode active material for a lithium ion secondary battery according to claim 7, wherein the lithium-containing composite oxide is represented by the following formula (2-1):
Li(LiₓMn_{y}Me_{z})OₚF_{q} (2-1)
wherein Me is at least one element selected from the group consisting of Co and Ni, 0.11≦x≦0.22, 0.55<y/(y+z)≦0.75, x+y+z=1, 1.9<p<2.1, and 0≦q≦0.1.

11. The process for producing a cathode active material for a lithium ion secondary battery according to claim 7, wherein the above first contact step and the above second contact step are carried out by a spray coating method.

12. A cathode for a lithium ion secondary battery, comprising the cathode active material for a lithium ion secondary battery as defined in claim 1, an electrically conductive material and a binder.

13. A lithium ion secondary battery comprising the cathode as defined in claim 12, an anode and a non-aqueous electrolyte.
